(19) United States
(12) Patent Application Publication
(10) Pub. No.: US 2002/0199204 A1
(43) Pub. Date: Dec. 26, 2002

(54) Generation of a description in a markup language of a structure of a multimedia content

(76) Inventors: Benoit Mory, Paris (FR); Joan Llach-Pinsach, Princeton, NJ (US)

Correspondence Address: U.S. Philips Corporation, 580 White Plains Road, Tarrytown, NY, 10591, US

(21) Appl. No.: 10/158,428

(22) Filed: May 30, 2002

(30) Foreign Application Priority Data
May 31, 2001 (FR) 0107170

(51) Int. Cl. H04N 7/173; H04N 7/16; G09G 5/00; G06F 3/00; H04N 5/445; G06F 13/00

(52) U.S. Cl. 725/113; 725/135; 345/731; 345/760; 345/723; 725/37

(57) ABSTRACT

The invention proposes a device which makes it possible to generate a description of a structure of a multimedia content, for example of a video. In accordance with the invention an initial imperfect structure is generated using an automatic extraction algorithm known per se. The device includes means of displaying a visual representation of the structure obtained, and graphical manipulation means for modifying it. The description of the structure is updated in order to take account of these modifications.

Application: MPEG-7 ; video description

Reference: FIG. 1.

### DESCRIPTION

### FIELD OF THE INVENTION

The invention relates to a device including means for generating a description in a markup language of a structure of a multimedia content including shots.

The invention also relates to a method of generating a description in a markup language of a structure of a multimedia content including shots.

It also relates to a program containing instructions for generating a description in a markup language of a structure of a multimedia content including shots, when it is executed by a processor.

The invention makes it possible in particular to generate descriptions, in accordance with the standard MPEG-7, of multimedia contents, for example video. Such descriptions facilitate the use of the multimedia content. They make it possible for example to make searches.

### TECHNOLOGICAL BACKGROUND TO THE INVENTION

The article entitled “Analysis of Video Content for Multi-Layer Navigation of Multimedia Documents” published by M. Bonnet, A. Bugatti, R. Leonardi and P. Migliorati, in the context of the conference “Int. Workshop on Very Low Bitrate Video, VLBV'99, Kyoto, Japan, Oct. 29-30, 1999”, describes an automatic extraction tool which makes it possible to generate a structure of a video document. This structure is a time structure of the table of contents type. It is for example described in a document in accordance with the MPEG-7 standard.

MPEG-7 is a multimedia content description standard. This standard describes in particular description schemes and descriptors. The descriptions which are in accordance with the MPEG-7 standard are instances of these description schemes. They are written in a markup language called XML defined by the W3C consortium.

The structure which is supplied by this type of extraction tool is necessarily imperfect since it is obtained automatically. The object of the invention is notably to propose a user-friendly tool which makes it possible to improve the structure obtained.

### SUMMARY OF THE INVENTION

In accordance with the invention, a device as described in the introductory paragraph is characterized in that it has:

means of displaying a visual representation of at least part of said structure, said visual representation including images representing shots,

graphical means of manipulating said visual representation in order to make modifications to said structure,

means of updating said description in order to take account of said modifications.

Thus the invention proposes a user-friendly tool enabling an operator to modify an initial structure supplied by an automatic extraction tool. The visual representation enables the operator to apprehend the content of the structure. This facilitates the determination of the modifications to be made to the current structure.

The invention for example relates to time structures of the table of contents type in which the shots are ordered chronologically, or hierarchical structures of the index type in which the shots are grouped by themes, sub-themes, keywords, etc, where one and the same shot may appear in several headings at the same time.

The graphical manipulation means advantageously include means of selection, cutting, pasting and copying of shots of said visual representation. They also have means for positioning and for eliminating delimitations between the shots of said visual representation.

Advantageously, a device according to the invention has means of displaying a tree representation of at least part of said structure and means of updating said tree representation in order to take account of said modifications.

Such a tree representation enables the operator to have an overall vision of the structure. Advantageously, the operator can simultaneously view the visual representation and the corresponding tree representation.

Typically such a tree representation has nodes, branches and leaves. Advantageously, a device according to the invention has means for developing or reducing one or more of said branches, a reduced branch being represented by a single image in said visual representation.

The operator can choose to develop only one, several or all the branches of the tree representation according to his requirements. The visual representation is adapted accordingly. The operator thus has the possibility of obtaining different views, more or less extensive, of said structure.

Advantageously, a device according to the invention has editing means for annotating said description. Some annotations are captured manually by the operator (for example annotations of the type which person, which action, which object, when, where, how, why etc), whilst others are supplied by an external algorithm initiated by the operator (for example annotations of the camera movement type, histogram of colors etc).

### BRIEF DESCRIPTION OF THE DRAWINGS

The invention will be further described with reference to examples of embodiment shown in the drawings to which, however, the invention is not restricted:

FIG. 1 is a block diagram describing the functionalities of an example of a device according to the invention,

FIG. 2 is a block diagram of an example of device according to the invention,

FIG. 3 is a diagram of an example of a visual representation according to the invention,

FIG. 4 is a diagram of an example of a tree representation according to the invention.

### DESCRIPTION OF PREFERRED EMBODIMENTS

A device according to the invention enables an operator to generate a description of a structure of a multimedia content. In general terms, the structure of a multimedia content has one or more hierarchical levels. Hereinafter, in order to simplify the disclosure, a structure with one hierarchical level is described. This is not limitative.

The multimedia content which is considered here contains shots. A shot is a sequence of consecutive video frames, generated by a continuous operation, and representing an action which is continuous in time and space.

FIG. 1 is a block diagram describing the functionalities of a preferred embodiment of a device according to the invention. In FIG. 1, a block 1 represents a multimedia content MC which contains shots. The multimedia content MC consists for example of a video. A block 2 represents a structure SS of the multimedia content MC. An initial structure is generated from the multimedia content MC using an automatic extraction tool EXT known per se and represented by a block 3. The device according to the invention generates:

a tree representation TR of the structure SS, represented by a block 4,

a visual representation VR of the structure SS, represented by a block 5,

a description DES of the structure SS, represented by a block 6.

The device according to the invention makes available to an operator OP, represented by a block 8, means for acting on the visual representation VR, on the tree representation TR and on the description DES. In FIG. 1, the action of the operator OP on the visual representation VR is represented by an arrow AV. This action consists of manipulating the visual representation VR so as to modify the structure SS. Following such a modification, the tree representation TR and the description DES are updated. These updates are represented by the arrows UT and UD. The action of the operator on the tree representation is represented by an arrow AT. This action consists of modifying the tree representation so as to obtain another view of the structure SS. It gives rise to an updating of the visual representation VR. This updating is represented by an arrow UV in FIG. 1. Finally, the action of the operator OP on the description DES is represented by an arrow AD. This action consists of annotating the description DES.

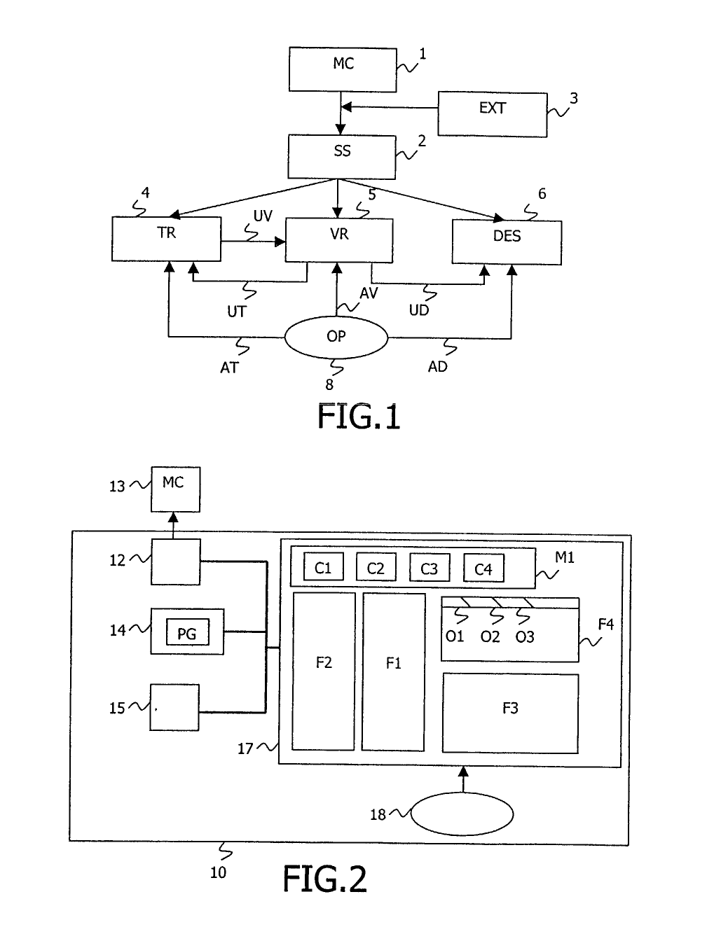

FIG. 2 depicts an example of device according to the invention referenced 10. According to FIG. 2, the device 10 has at least means 12 of reading a data memory 13, a program memory 14 and a processor 15. The data memory consists for example of a component, a hard disk or a removable support of the disk, cassette, diskette etc type. It can also be integrated into a semiconductor device having one or more other functions. It forms part or not of the device 10. It contains the multimedia content MC. The program memory 14 contains notably a program PG which contains instructions for implementing the functionalities which have been described with regard to FIG. 1. When it is executed by the processor 15, the program PG generates a description DES, in a markup language, of a structure SS of a multimedia content MC stored in a data memory. The device 10 also has a user interface 16 comprising a display screen 17 and means 18 of pointing and selecting on the screen 17. The pointing and selection means 18 consist for example of a mouse or a keyboard.

In a particularly advantageous embodiment, the display screen 17 is used to display one or more windows Fi (i=1, 2, . . . ) and one or more menu bars Mj (j=1, 2, . . . ). In particular one window F1 at least is devoted to the display of a visual representation of at least part of a structure of the multimedia content MC. And a menu bar M1 offers the user at least some means of graphical manipulation of the visual representation displayed in the window F1. By way of example, the menu bar includes an icon C1 for cutting an image previously selected in the visual representation, an icon C2 for copying an image previously selected in the visual representation and an icon C3 for pasting an image of the visual representation previously cut or copied.

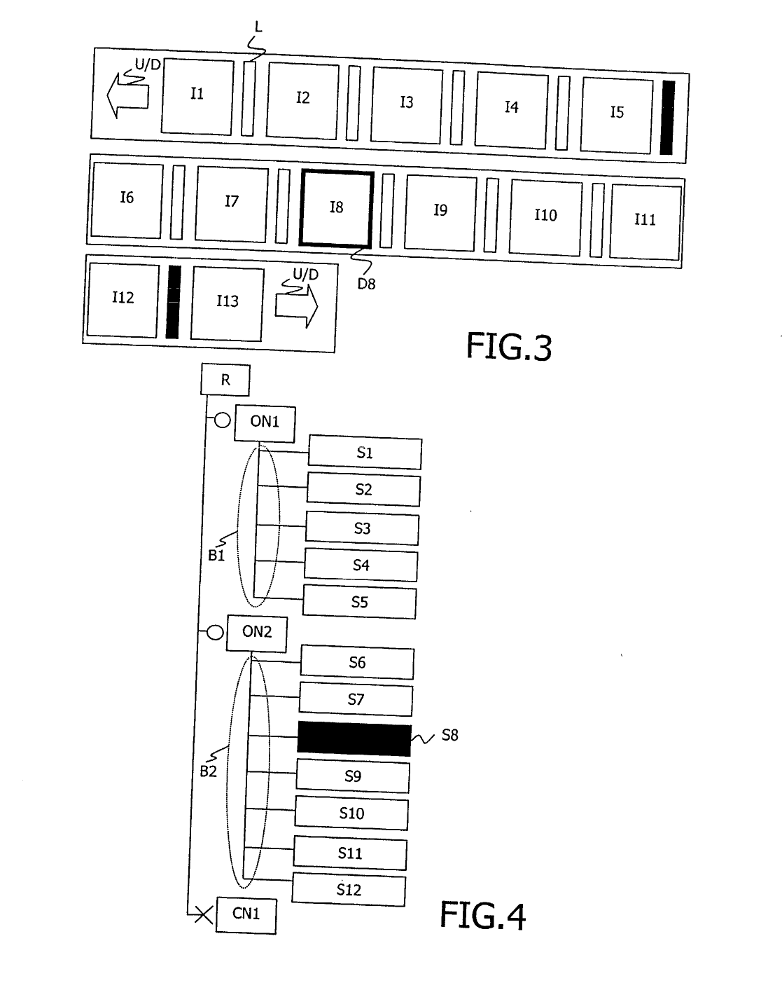

FIG. 3 depicts an example of such a visual representation. The visual representation of FIG. 3 consists of a sequence of thirteen images referenced I1 to I13. Each image in the sequence represents a shot or a set of shots.

The images in the sequence are separated from each other by delimitations L which can be activated and deactivated. For example, the operator can modify the active or inactive state of a delimitation by selecting it with the pointing and selection means 18. When the operator selects a delimitation, the representation on the screen of this delimitation is modified. For example, an inactive delimitation is represented by a rectangle having a transparent background, whilst an active delimitation is represented by a black rectangle. In FIG. 3, two delimitations are activated: the delimitation which separates the images I5 and I6, and the delimitation which separates the images I12 and I13.

In addition, a specific graphical representation is advantageously used for representing the image or images in the sequence which are selected at a given instant. For example, in FIG. 3, the selected image I8 is framed in a frame D8.

Advantageously, a scroll bar U/D is provided to make it possible to scroll the visual representation displayed on the screen in order to display the required part of the image sequence.

In an advantageous embodiment, another window F2 is devoted to the display of a tree representation of at least part of the structure of the multimedia content MC. Such a tree representation has a root, nodes, branches and leaves. When the structure has one hierarchical level, each leaf is attached to the root by means of a single node. Advantageously, means are provided for developing or reducing the branches of the tree representation. For this purpose there are open nodes and closed nodes in the tree representation. A reduced branch is represented by a closed node in the tree representation and by a single image in the visual representation. A developed branch is attached to an open node in the tree representation. When the structure has only one hierarchical level, the developed branches carry leaves which are each represented by an image in the visual representation. When the structure has several hierarchical levels, the developed branches can also carry nodes, which are either open or closed.

When the operator modifies the tree representation, the visual representation is adapted accordingly.

Likewise, the tree representation is updated to take account of the modifications in structure made by the operator on the visual representation displayed in the window F1. In particular, when a delimitation is activated in the visual representation, a node is created in the tree representation, and the leaves which represent the images which follow said delimitation are attached to the node thus created. Conversely, when a delimitation is deactivated in the visual representation, the corresponding node in the tree representation is omitted, and the leaves which were previously attached to the omitted node are attached to the node which preceded the omitted node in the tree representation.

Thus, at any time, the views given by the tree and visual representations correspond to each other.

Various embodiments can be envisaged. For example, in a first embodiment, the operator modifies the open or closed state of a node by selecting it with the pointing and selection means I1. When the operator develops a branch, the nodes on this branch are either initially open or initially closed. In addition, the menu bar M1 advantageously has an icon C4 for defining a development level for the entire tree structure.

Advantageously, the open nodes and the closed nodes are not depicted in the same way: for example, the open nodes are preceded by a circle and the closed nodes are preceded by a cross.

FIG. 4 gives an example of a tree representation according to the invention which corresponds to the visual representation described in FIG. 3. This representation has a root R, two open nodes ON1 and ON2, and a closed node CN1. A branch B1 is attached to the open node ON1. This branch B1 carries five leaves S1, S2, S3, S4 and S5 which correspond respectively to the images I1 to I5 of the visual representation. A branch B2 is attached to the open node ON2. This branch B2 carries seven leaves S6, S7, S8, S9, S10, S11 and S12 which correspond respectively to the images I6 to I12 of the visual representation. Finally, the closed node CN1 corresponds to the image I13 of the visual representation.

Advantageously, a specific representation is used to indicate, in the tree representation, the image or images which are selected. In FIG. 4, the selected image I8 is represented by a black rectangle, whilst the other images which are not selected are represented by a white rectangle.

In another advantageous embodiment, another window F3 is devoted to the display of the description of the current structure. Advantageously, this description is an MPEG-7 description, written in the XML markup language. To each node in the tree representation there corresponds a “Video Segment” element in the MPEG-7 description. Each “Video Segment” element of the MPEG-7 description contains a certain number of other elements, some of which are used to annotate the description. For example, MPEG-7 defines amongst other things elements intended to be used for describing the type, the object, the subject, the place, the time, the reason for the action, the histogram of colors used, the movement of the camera etc.

Some of this information has to be entered directly by the operator, whilst other items of information are produced by dedicated programs (this is the case for example with the histogram of colors, or the movement of the camera).

Advantageously, an editing window F4 is provided for entering information or launching a program intended to generate information. For example, the editing window F4 has a tab for each type of information liable to be added in the description DES. FIG. 2 shows three tabs referenced O1 to O3. The selection of a tab which corresponds to information produced from a dedicated program gives rise to the launching of said dedicated program.

The invention is not limited to the embodiments which have just been described by way of example. In particular:

the number of windows displayed simultaneously may be any number,

many variants, easily imaginable to a person skilled in the art, are possible for the graphical interface and for the graphical manipulation tools,

the number of hierarchical levels of the structure may be any in number; when the structure can have more than one hierarchical level, means (for example graphical means) must be made available to the operator to enable him to create or eliminate one hierarchical level; such means can easily be imagined by a person skilled in the art.

A preferred embodiment has been described in which the equipment according to the invention has means of displaying a visual representation, but also means of displaying a tree representation and means of displaying a description of a current structure.

In another non-preferred embodiment, the equipment has only means of displaying the visual representation, graphical means of manipulating the visual representation displayed and means of updating the description of the structure. This embodiment enables the operator to modify the initial structure supplied by the automatic extraction tool. It does not enable him to annotate the description.

1. A device (10) including means for generating a description (DES) in a markup language of a structure of a multimedia content (MC) including shots, characterized in that it has:
means of displaying a visual representation (VR) of at least part of said structure, said visual representation including images (I1-I13) representing shots,
graphical means (14, 15, 17, 18, M1, F1-F4) of manipulating said visual representation in order to make modifications to said structure,
means (14, 15) of updating said description in order to take account of said modifications.

2. A device as claimed in claim 1, characterized in that it has editing means (F4, O1-O3) for annotating said description.

3. A device as claimed in claim 1, characterized in that it has means of displaying a tree representation (TR) of at least part of said structure and means (14, 15) of updating said tree representation in order to take account of said modifications.

4. A device as claimed in claim 3, characterized in that, said tree representation including nodes (ON1, ON2, CN1), branches and leaves (S1-S12), it has means for developing or reducing one or more of said branches, a reduced branch being represented by an image in said visual representation.

5. A method of generating a description (DES) in a markup language of a structure of a multimedia content including shots, characterized in that it includes a step (AV) of manipulating a visual representation (VR) of at least part of said structure, said visual representation including images (I1-I13) representing shots, using a graphical tool (M1, F1-F4, 17, 18), for making modifications to said structure, said description being updated automatically (UD) in order to take account of said modifications.

6. A method as claimed in claim 5, characterized in that it includes a step (AD) of annotating said description using an editing tool.

7. A program (PG) containing instructions for generating a description (DES) in a markup language of a structure of a multimedia content (MC) including shots, when it is executed by a processor (15), characterized in that said instructions include:
instructions for displaying a visual representation (VR) of at least part of said structure, said visual representation including images (II-I13) representing shots,
instructions for offering to a user a graphical tool (17, 18, M1, F1-F4) for manipulating said visual representation in order to make modifications (AV) to said structure,
instructions for updating said description (UD) for taking account of said modifications.

8. A program as claimed in claim 7, characterized in that said instructions include instructions for offering to a user an editing tool (F4, O1-O3) making it possible to annotate said description (AD).

9. A program as claimed in claim 7, characterized in that said instructions include instructions for displaying a tree representation (TR) of at least part of said structure, and instructions for updating said tree representation (UT) for taking account of said modifications (AV).

10. A program as claimed in claim 9, characterized in that, said tree representation including nodes (ON1, ON2, CN1), branches and leaves (S1-S12), said instructions include instructions for developing or reducing one or more of said branches, a reduced branch being represented by an image in said visual representation.
